(19) United States
(12) Patent Application Publication
(10) Pub. No.: US 2012/0278184 A1
(43) Pub. Date: Nov. 1, 2012

(54) Combination of Social Networking Data With Other Data Sets for Estimation of Viewership Statistics

(76) Inventors: Sean Micheal Bruich, Palo Alto, CA (US); Bradley Hopkins Smallwood, Palo Alto, CA (US)

(21) Appl. No.: 13/098,306

(22) Filed: Apr. 29, 2011

(51) Int. Cl. G06Q 30/00

(52) U.S. Cl. 705/14.73

(57) ABSTRACT

Embodiments of the invention combine information from different data sets, such as social networks, advertising networks, and/or panels, each data set comprising statistics about past viewership of content (e.g., advertisements). The result of the combination is a model that, when applied to statistics about viewing of particular content, produces viewing statistics about the particular content that are more accurate than the data of any given one of the different data sets when taken in isolation.

### BACKGROUND

The present invention generally relates to the field of computer data storage and retrieval, and more specifically, to deriving information for estimating viewership of digital content such as online advertisements.

Disseminators of digital content via the Internet are often interested in estimating the viewership of that content. For example, advertisers that provide digital advertisements for display on web sites are interested in estimating the number of impressions (total separate displays) that a particular advertisement produced with respect to different demographic attributes of interest, such as different age groups, males or females, those with particular interests (e.g., tennis), and the like.

In the context of television advertisements, selected surveying panels of households and/or individuals can be directly or indirectly surveyed regarding their television viewing habits. However, in order to be statistically representative these panels must be of a substantial size, and thus panels are of little utility in contexts where there is not a large audience to be surveyed. For example, few, if any, individual web sites have the number of viewers needed to form a panel providing sufficient accuracy.

Some web sites, such as social networking sites, have a very large user base and thus have access to a wealth of demographic and statistical data. For example, user data on social networking sites typically includes information such as age, sex, and interests, as well as users' historical reactions to advertisements previously presented. However, the user base of these social networking sites typically does not perfectly represent, demographically, the population in general or that of another web site on which advertisements might be placed. For example, the user demographics of a given social networking site are unlikely to perfectly match that of an online news web site. Thus, although the user data on a social networking site could be directly used to estimate the effectiveness of an advertisement placed on the example online news web site, the accuracy of the estimate could be enhanced.

Machine-based tracking techniques, such as the use of cookies employed by many advertising providers for tracking user reactions to advertisements, result in a large volume of data drawn from across many different web sites. However, such data is associated with a particular computing device (e.g., a personal computer), rather than with an individual. In contrast, social networking sites and other login-based systems avoid the problems of multiple people sharing the same computer device, or one person using multiple distinct computer devices.

In general, the different types of data, such as panel data, data from social networks or other web sites with a notion of user identify, and machine-based tracking techniques all have their own distinct advantages and limitations for estimating viewership of online content.

### SUMMARY

Embodiments of the invention combine information from different data sets, such as data from social networking systems, advertising networks, and/or panels corresponding to different web sites. Each of the data sets may comprise demographic information about the users and statistics about the users' past viewership of content (e.g., advertisements). The data resulting from the combination may be used to compute an estimation model that more accurately estimates the users' viewership of content than would the use of the data of any given one of the different data sets when taken in isolation.

In one embodiment, the estimated viewing statistics produced by the model for an advertisement or other content comprise estimated statistics—such as a reach value (a number of distinct users estimated to have viewed the advertisement) and a frequency value (a number of times that an average user is estimated to have viewed the advertisement)—for values of a set of demographic attributes of interest. For example, the values of demographic attributes of interest might include a set of age ranges, or males and females. Use of the rich data sets from social networking systems, for example, allows analysis of demographic attributes such as specific interests (e.g., a particular sport, such as tennis), education level, or number of friends, that are entered by users of the social networking systems or inferred based on user activity. Viewing statistics with respect to combinations of demographic attributes (e.g., males aged 20-24) may also be analyzed.

The data sets are combined using different techniques in different embodiments, resulting in a model that estimates viewing statistics for content for which the viewing statistics have not already been verified. The estimated viewing statistics may include values for the individual demographic attributes and/or combinations thereof, and aggregate values across all demographic groups (e.g., an estimated total number of impressions). The techniques that can be used to produce the model include, for example, supervised learning and Bayesian techniques.

As one specific example, a particular model might output estimated reach and frequency values of a given advertisement for each of a set of age ranges, for males, for females, for each of a set of education levels (e.g., high school, college, or graduate degrees), and for each of a set of interests, as well as aggregate reach and frequency values.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram of a computing environment, according to one embodiment.

FIG. 2 illustrates the computation of an estimation model using data from different data sets, according to one embodiment.

FIG. 3 is a flowchart illustrating steps performed by the statistics module 114 when computing the estimation model and applying the estimation model to estimate viewing statistics for a given advertisement or other content, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

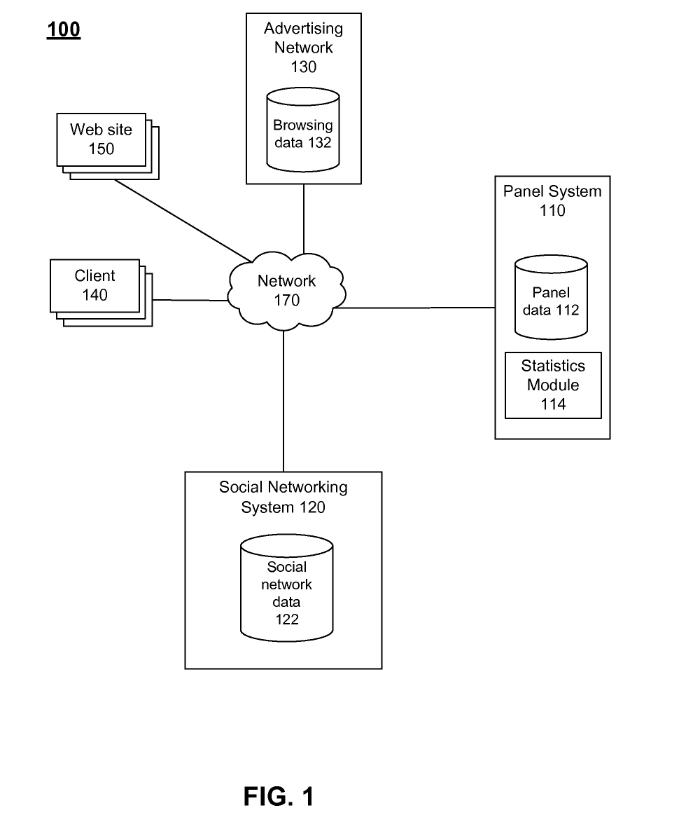

FIG. 1 is a high-level block diagram of a computing environment according to one embodiment. FIG. 1 illustrates a set of distinct data sources 110, 120, 130 storing data obtained based on prior activity of users, a set of client devices 140 used by the users to directly or indirectly provide the data stored by the data sources 110, 120, 130, and a statistics module 114 used to combine and refine the information stored by the data sources 110, 120, 130. FIG. 1 additionally illustrates one or more web sites 150 that provide content that users can view on the client devices 140, such as advertisements, videos, images, and the like.

More specifically, the illustrated data sources include a panel system 110, a social networking system 120, and an advertising network 130. The panel system 110 stores surveying panel data 112, representing the aggregate data provided by a set of households or individual users making up a panel, with respect to a particular web site. As previously described, a surveying panel is a group of people chosen to be statistically representative of the overall audience for some content of interest, such as the viewers of one of the web sites 150. The data tracked for a given panel typically includes information about the number of times that a household in the aggregate, or the individual members of the household, viewed content of interest, such as a particular advertisement, on the corresponding web site 150. The data for a panel typically further includes general information on the household itself and/or the individual members thereof. For example, in one embodiment the panel data includes advertisement information such as how many times each member of a particular household was presented with advertisements on the particular web site 150, and demographic information such as the number of members of the household and the age and sex of each member, the location of the household, aggregate household income, and aggregate purchasing behavior (e.g., particular products purchased). The demographic information associated with the households tends to be highly accurate, since the panel members are surveyed and their answers confirmed before they are accepted as members of the panel. However, it may be difficult to determine which particular members of the household viewed the content.

As an example of advertisement statistics for one hypothetical set of data, the panel data 112 might include the following, indicating that a first household was presented with a first ad 12 times (clicking it once) and with a second ad four times (clicking it once), that a second household was presented with the first ad 11 times (clicking it twice):

| Household ID | Ad ID | Impressions | Clicks |
|---|---|---|---|
| 1 | 1 | 12 | 1 |
| 1 | 2 | 4 | 1 |
| 2 | 1 | 11 | 2 |

Additionally, the panel data 112 in the example would include, for each user, the demographic information related to the households, as described above.

The social networking system 120 stores social network data 122 derived, directly or indirectly, from use of the social network, such as viewing histories of content such as advertisements, videos, images, etc., and social information such as connections and profile information. For example, in one embodiment the social network data 122 comprises, for each distinct individual user, how many times that user was presented with a particular advertisement while using the social network, how many times the user “clicked” the advertisement, and manually-specified user information. The manually-specified user information is information about the user, including profile information such as user name, age, sex, birthday, interests (e.g., favorite sport or musical genre), and friends or other connections on the social networking system 120. Not all of the user information need be manually-specified by the user; some of the information may be inferred by the social networking system 120 based on user activity or relationships (e.g., inferring that the user is interested in basketball based on frequent postings related to basketball, or on his affiliation with basketball-related organizations on the social networking system). As an example of advertisement statistics for one hypothetical set of data, the social network data 122 might include the following, indicating that a first user was presented with a first ad 10 times (clicking it once) and with a second ad five times (clicking it once), that a second user was presented with the first ad 8 times (clicking it twice), and that a third user was presented with a third ad 12 times (clicking it 3 times):

| User ID | Ad ID | Impressions | Clicks |
|---|---|---|---|
| 1 | 1 | 10 | 1 |
| 1 | 2 | 5 | 1 |
| 2 | 1 | 8 | 2 |
| 3 | 3 | 12 | 3 |

Additionally, the social network data 122 would include, for each user, profile information and a list of the user's connections.

The social network data 122 represents a strong understanding of user identity, due to the login-based nature of the social networking system 120 which requires some validation of user identity. The social network data 122 may contain inaccuracies due (for example) to user dishonesty when submitting information (e.g., a false age), though this inaccuracy may be mitigated by flagging and correcting possible inaccuracies based on other known data, as described in more detail below. The social network data 122 is typically rich, containing information on attributes that may have a strong influence on content viewing patterns, such as number of social network friends, number of books read over some recent time period.

The advertising network 130 aggregates data from user web browsing on a client 140, e.g., via tracking cookies placed on the user's browsing device via HTTP response headers. The advertising network serves advertisements to participating web sites, selecting advertisements to be placed on their various web pages. The advertising network 130 stores browsing data 132 that includes, for a given device identifier such as an IP address, a list of the advertisements provided to that machine along with the number of times that the advertisements were presented and “clicked,” and a browsing history comprising URLs visited from that device. The browsing data 132 typically lack as strong a notion of user identity as the social network data 122. On the other hand, given that the advertising network 130 usually provides advertisements for a large number of participating websites, the browsing data 132 tends to include data on a large number of impressions of advertisements or other content, resulting in a larger data set.

As an example for advertisements statistics for one hypothetical set of data, the browsing data 132 might include the following, indicating that a first device was presented with a first ad 15 times (with users of the device clicking it twice) and with a second ad 11 times (clicking it once), and that a second user was presented with a third first ad 22 times (clicking it 3 times):

| Device ID | Ad ID | Impressions | Clicks |
|---|---|---|---|
| 1 | 1 | 15 | 2 |
| 1 | 2 | 11 | 1 |
| 2 | 1 | 22 | 3 |

Additionally, the browsing data 132 would include, for each distinct device, a browsing history for that device, as described above.

Users use the client devices 140 to provide data to the data sources 110, 120, 130, either directly or indirectly, and to view content, such as content available on a web site 150. The data may be provided via the network 170, which is typically the Internet, but may also be any network, including but not limited to a LAN, a MAN, a WAN, a mobile, wired or wireless network, a private network, or a virtual private network. It is understood that very large numbers (e.g., millions) of client devices 140 can be in communication with the various data sources 110-130 at any given time. The client devices 140 may include a variety of different computing devices. Examples of client devices 140 include personal computers, mobile phones, smart phones, laptop computers, tablet computers, and digital televisions or television set-top boxes with Internet capabilities. As will be apparent to one of ordinary skill in the art, other embodiments may include devices not listed above. Different types of client devices 140 may be more suited for communicating with different ones of the data sources 110, 120, 130. For example, devices with web browsers, such as personal computers, smart phones, and the like are particularly suited for interacting with the social networking system 120 and the advertising network 130, whereas television set-top boxes may be more suitable for monitoring and providing data to the panel system 110. Not all of the data stored by the various data sources 110-130 need be provided directly by the client devices 140 over the network 170. For example, panel members may provide information to the panel system 110 in response to surveys provided via telephone or physical mail.

The data related to viewing of content is gathered in different manners for the different data sources 110, 120, 130. For example, the panel data 112 on content viewing is usually obtained as a result of user installation of software by members of the panel. Specifically, the members of a household that is part of the panel installs software on (for example) their personal computers, and the software tracks the content that the household members view and provides this information to the panel system 110, which stores it as part of the panel data 112. The social network data 122 related to content viewing is captured directly by the social networking system 120, which has knowledge of the accesses to content of its users. The browsing data 132 related to content viewing is obtained by the the advertising network 130 tracking user viewing of advertisements via cookies supplied as part of a HTTP responses and stored on the user devices.

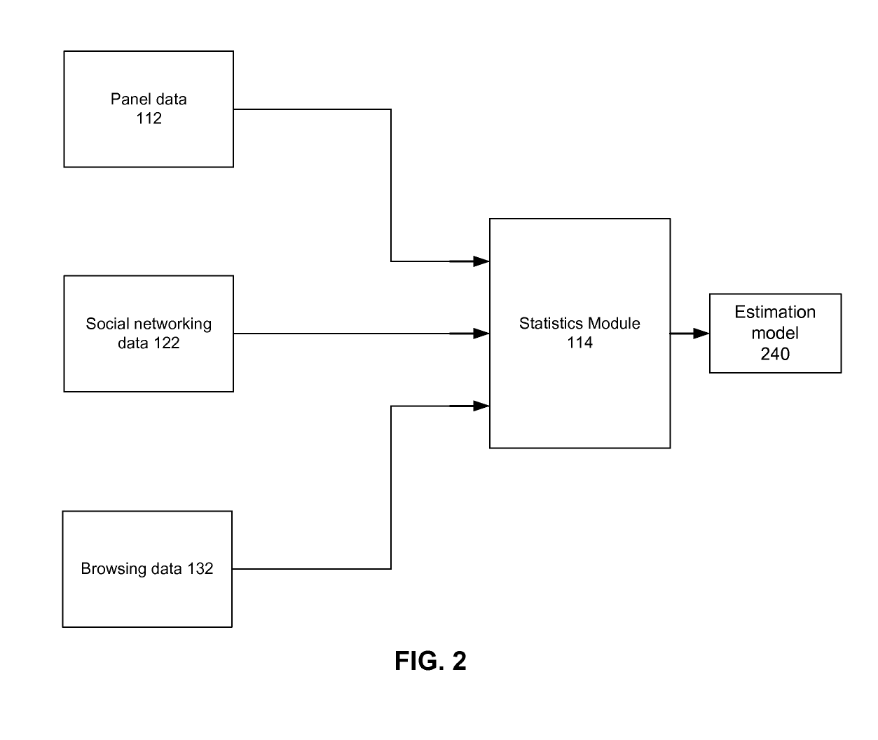

The statistics module 114 computes an estimation model using a combination of data from two or more of the data sources 110, 120, 130. In one embodiment, the statistics module additionally provides estimated viewing statistics for a given advertisement or other content using the estimation model. The operations of the statistics module 114 are discussed further below with respect to FIG. 2.

It is appreciated that FIG. 1 illustrates a computing environment 100 according to one particular embodiment, and that the exact constituent elements and configuration of the computing environment could vary in different embodiments. For example, although FIG. 1 depicts three specific information sources—the panel system 110, the social networking system 120, and the advertising network 130—there could be more or fewer information sources, or information sources of different types. For example, the environment 100 could include only the panel system 110 and the social networking system 120, but not the advertising network 130. As another example, the statistics module 114, although depicted in FIG. 1 as part of the panel system 110, could reside on any system capable of accessing the data stored by the various information sources, such as one of the information sources themselves, or on a separate system that accesses their information via the network 170 or another means.

Specifically, FIG. 2A illustrates the derivation of a model from the data sources 110, 120, 130. The statistics module 114 receives the panel data 112 from the panel system 110, social network data 122 from the social networking system 120, and browsing data 132 from the advertising network 130. The statistics module 114 then combines the different data using a data integration technique, the specifics of which differ in different embodiments, resulting in an estimation model 240. For example, in one embodiment the statistics module 114 combines the panel data 112 for that web site with the social network data 122.

The combination of the data sets 112, 122, 132 from the different data sources 110, 120, 130 addresses the shortcomings inherent in each data set when it is used in isolation. For example, the panel data 112 for each web site 150 is obtained from a set of users specifically chosen to be statistically representative of the audience which the panel measures, i.e., the audience for that web site. However, due to the cost of manually selecting the members of the panel, the size of the panel is typically very small, with one panelist representing millions of Americans (for example). In consequence, the panel data 112, though generally representative, tends to be “noisy.” Likewise, the social network data 122 may include data for all of the users of the social network, such as the advertisements presented to the various users and how the users reacted to the advertisements (e.g., whether they clicked them). Thus, the social network data 122 may provide a data set that is quite comprehensive and detailed. However, the audience of the social networking system 120 is unlikely to be perfectly representative of the audience for a particular web site 150 on which advertising is to be presented. The browsing data 132 includes considerable information about how many advertisements were served and “clicked” across a large group of users. However, the browsing data 132 don't track the actual identities of the users to whom the ads were served, but merely the corresponding device identifiers. Thus, when multiple users use the same machine, their actions with respect to the advertisements cannot be distinguished. Thus, using only the social network data 122 (for example) to approximate the estimated viewing statistics of a piece of content on a web site outside of the social network would result in a higher degree of inaccuracy than if a combination of the social network data 122 and the panel data 112 and/or the browsing data 132 were used for that purpose, with the panel data/browsing data in effect correcting any lack of representativeness of the social networking data.

In one embodiment, the statistics module 114 need not accept the data provided by the sources 110, 120, 130 as-is, but may instead modify the data for greater accuracy. That is, either the statistics module 114 can modify the data sets provided by the different data sources 110, 120, 130 before combining the data sets, or the content sources themselves can perform the modifications before providing the data sets to the statistics module 114. For example, a portion of the user-entered information within the social network data 122 may be rejected or modified based on other social data associated with that user, where the other social data indicates that the portion is inaccurate. As a specific example, a particular user may list herself in her profile as being 107 years old, but if the majority of her friends are aged 20-24, she has recently listed a college as her current educational institution, and she has a high school graduation date three years prior to the current date, her age might be adjusted to the most probably correct age (e.g., 21) before the statistics module 114 combines the social network data 122 with any other data set.

Different algorithms may be used in different embodiments to perform the derivation of the estimation model 240. For example, possible techniques include supervised machine learning, Bayesian techniques, or weighting segments, each of which is known to one of skill in the art. “Ground truth” may be supplied by, for example, performing a comprehensive survey regarding viewing of some subset of the content.

The estimation model 240, in essence, maps the viewing statistics for the different data sets 112, 122, 132 used to train the model to a single set of statistics that is more likely to be accurate. Thus, for given content for which actual viewing statistics have not been verified, the viewing statistics produced by the data sources 110, 120, 130 can be provided as inputs to the estimation model 240, which outputs a set of viewing statistics with greater probable accuracy than any input viewing statistics taken in isolation.

In one embodiment, the estimated viewing statistics produced by the estimation model 240 for a given advertisement or other content comprise, for each demographic attribute of interest (or combinations of demographic attributes, such as males aged 15-19), estimated viewing statistics. In one embodiment, the estimated viewing statistics include the reach and frequency. As an example for a hypothetical set of data, the viewing statistics could include, in part, the following data, illustrating estimated statistics for various demographic attributes (i.e., age groups 15-19 and 20-25, males, females, and those interested in basketball):

| Attribute | Reach | Frequency |
|---|---|---|
| Age 15-19 | 15,282 | 2.83 |
| Age 20-25 | 20,969 | 3.4 |
| Sex: Male | 25,892 | 2.38 |
| Sex: Female | 35,223 | 5.4 |
| Interest: | 12,347 | 1.3 |
| Basketball | | |

Thus, in viewing the estimated statistics of this example, the advertiser associated with the advertisement could determine that the advertisement likely fared considerably better with women than with men, and somewhat better with the age group 15-19 than with the age group 20-25, for example, in addition to determining the estimated reach and frequency values themselves.

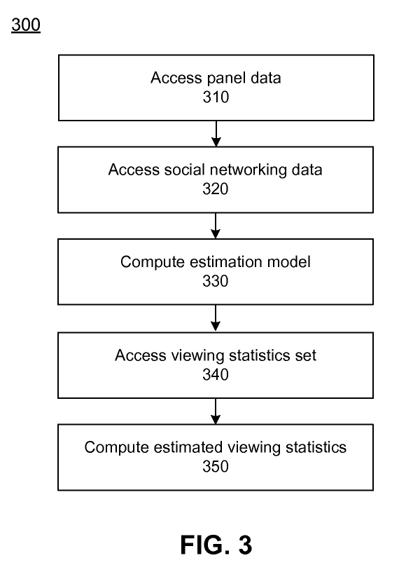

FIG. 3 is a flowchart illustrating steps performed by the statistics module 114 when computing the estimation model 240 and applying the estimation model to compute estimated viewing statistics for a given advertisement, according to one embodiment. In step 310, the statistics module 114 accesses the panel data 112 for the various web sites 150. The panel data 112 may be stored locally, as in the embodiment of FIG. 1, or it may be stored remotely, in which case the statistics module 114 may request the data via the network 170. In general, the panel data corresponds to households of viewers, as opposed to corresponding to the individual members of the household. That is, the individual data items specify an association with the household as a whole, not with its individual members. Likewise, in step 320 the statistics module 114 accesses the social network data 122, either locally or remotely via the network 170, depending on the configuration of the environment 100 of the embodiment.

In step 330, the statistics module 114 computes the estimation model from the panel data 112 and the social network data 122 using one of the techniques noted above, such as machine learning or Bayesian techniques. The estimation model can be viewed as being representative of the social network data 122, adjusted by the panel data 112, thereby more perfectly tailoring the social network data to a representative audience.

With the estimation model having been derived, the statistics module 114 can apply the estimation model to estimate the viewing statistics for a given advertisement, or other content of interest. Specifically, the statistics module 114 accesses 340 a viewing statistics set, comprising first statistics for the advertisement from the surveying panel and second statistics for the advertisement from the social networking system. These statistics have not been previously verified, e.g. by an in-depth survey, and hence likely contain inaccuracies. The statistics module 114 provides the first and second statistics to the estimation model, thereby computing 350 estimated viewing statistics for display of the advertisement. As described above, such estimated viewing statistics include, for values of each demographic attribute of interest (e.g., various age groups, or male/female groups), estimated viewing statistics, such as the estimated reach and frequency of the advertisement.

In the foregoing discussion, it is appreciated that an advertisement is merely one type of content, and that the techniques discussed above could likewise be applied for deriving an estimation model for a type of content other than advertisements, and applying that estimation model to content of that type to estimate the content's viewing statistics.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
accessing panel data obtained from a surveying panel and comprising statistics corresponding to households of viewers;
accessing social networking data obtained from a social networking system and comprising statistics corresponding to individual users of the social networking system;
computing an estimation model using both the panel data and the social networking data;
accessing first statistics for an advertisement from the surveying panel and second statistics for the advertisement from the social networking system; and
computing estimated viewing statistics for the advertisement at least in part by providing the first statistics the second statistics as input to the estimation model.

2. The computer-implemented method of claim 1, further comprising:
accessing ad network data obtained from an advertising network and comprising statistics corresponding to individual computing devices;
further computing the estimation model using the ad network data;
accessing third statistics for the advertisement from the advertising network; and
further computing the estimated viewing statistics at least in part by providing the third statistics as input to the estimation model.

3. The computer-implemented method of claim 2, wherein the ad network data comprises:
statistics on presentations of advertisements to the computing devices; and
browsing histories associated with ones of the computing devices.

4. The computer-implemented method of claim 1, wherein the panel data comprises:
statistics on presentations of advertisements to the households; and
demographic data about ones of the households.

5. The computer-implemented method of claim 1, wherein the social networking data comprises, for each of a plurality of the individual users of the social networking system:
statistics on presentations of advertisements to the user; and
user-specific information about the user specified by the user.

6. The computer-implemented method of claim 5, further comprising:
identifying, for the user, a portion of the user-specific information that other portions of the user-specific information indicate is inaccurate;
determining a probable value for the portion based on the other portions of the user-specific information; and
modifying the portion to the probable value, before deriving the hybrid data.

7. The computer-implemented method of claim 1, wherein the estimated viewing statistics comprise, for each of a plurality of demographic attributes, an estimated reach value and an estimated frequency value for the advertisement when presented to viewers having the demographic attribute.

8. A computer-readable storage medium having executable computer program instructions embodied therein that when executed by a processor perform actions comprising:
accessing panel data obtained from a surveying panel and comprising statistics corresponding to households of viewers;
accessing social networking data obtained from a social networking system and comprising statistics corresponding to individual users of the social networking system;
computing an estimation model using both the panel data and the social networking data;
accessing first statistics for an advertisement from the surveying panel and second statistics for the advertisement from the social networking system; and
computing estimated viewing statistics for the advertisement at least in part by providing the first statistics the second statistics as input to the estimation model.

9. The computer-readable storage medium of claim 8, the actions further comprising:
accessing ad network data obtained from an advertising network and comprising statistics corresponding to individual computing devices;
further computing the estimation model using the ad network data;
accessing third statistics for the advertisement from the advertising network; and
further computing the estimated viewing statistics at least in part by providing the third statistics as input to the estimation model.

10. The computer-readable storage medium of claim 9, wherein the ad network data comprises:
statistics on presentations of advertisements to the computing devices; and
browsing histories associated with ones of the computing devices.

11. The computer-readable storage medium of claim 8, wherein the panel data comprises:
statistics on presentations of advertisements to the households; and
demographic data about ones of the households.

12. The computer-readable storage medium of claim 8, wherein the social networking data comprises, for each of a plurality of the individual users of the social networking system:
statistics on presentations of advertisements to the user; and
user-specific information about the user specified by the user.

13. The computer-readable storage medium of claim 12, the actions further comprising:
identifying, for the user, a portion of the user-specific information that other portions of the user-specific information indicate is inaccurate;
determining a probable value for the portion based on the other portions of the user-specific information; and
modifying the portion to the probable value, before deriving the hybrid data.

14. The computer-readable storage medium of claim 8, wherein the estimated viewing statistics comprise, for each of a plurality of demographic attributes, an estimated reach value and an estimated frequency value for the advertisement when presented to viewers having the demographic attribute.

15. A computer system comprising:
a computer processor; and
a computer program executable by the computer processor and when executed performing actions comprising:
accessing panel data obtained from a surveying panel and comprising statistics corresponding to households of viewers;
accessing social networking data obtained from a social networking system and comprising statistics corresponding to individual users of the social networking system;
computing an estimation model using both the panel data and the social networking data;
accessing first statistics for an advertisement from the surveying panel and second statistics for the advertisement from the social networking system; and
computing estimated viewing statistics for the advertisement at least in part by providing the first statistics the second statistics as input to the estimation model.

16. The computer system of claim 15, the actions further comprising:
accessing ad network data obtained from an advertising network and comprising statistics corresponding to individual computing devices;
further computing the estimation model using the ad network data;
accessing third statistics for the advertisement from the advertising network; and
further computing the estimated viewing statistics at least in part by providing the third statistics as input to the estimation model.

17. The computer system of claim 16, wherein the ad network data comprises:
statistics on presentations of advertisements to the computing devices; and
browsing histories associated with ones of the computing devices.

18. The computer system of claim 15, wherein the panel data comprises:
statistics on presentations of advertisements to the households; and
demographic data about ones of the households.

19. The computer system of claim 15, wherein the social networking data comprises, for each of a plurality of the individual users of the social networking system:
statistics on presentations of advertisements to the user; and
user-specific information about the user specified by the user.

20. The computer system of claim 15, wherein the estimated viewing statistics comprise, for each of a plurality of demographic attributes, an estimated reach value and an estimated frequency value for the advertisement when presented to viewers having the demographic attribute.
